(19) United States
(12) Patent Application Publication
(10) Pub. No.: US 2019/0343084 A1
(43) Pub. Date: Nov. 14, 2019

(54) LEASH TRAINING SYSTEM AND METHOD OF USE

(71) Applicant: Philip Mason, ARLINGTON, TX (US)

(72) Inventor: Philip Mason, ARLINGTON, TX (US)

(21) Appl. No.: 16/185,240

(22) Filed: Nov. 9, 2018

Related U.S. Application Data
(60) Provisional application No. 62/593,274, filed on Dec. 1, 2017.

(51) Int. Cl. A01K 27/00

(52) U.S. Cl. CPC A01K 27/003; A01K 15/02; A01K 27/005; A01K 27/001

(57) ABSTRACT

A leash training system includes an attachment device having a body formed by a frame curved to form a top chamber and a bottom chamber; the frame having a first end, a second end, and a curved portion extending inwardly and across from the first end; a gap formed between the first end and the second end and providing access to the bottom chamber; and a spring gate attached to the first end and to close against the curved portion, thereby closing off the top chamber; a dog control device to secure to a dog; and a leash; the attachment device is to secure to the dog control device; and the leash is to secure to the attachment device via a clip and wrap around a mid-section of the dog and secure back to the attachment device by slipping a portion of the leash through the gap.

### BACKGROUND

### 1. Field of the Invention

The present invention relates generally to leash training systems, and more specifically, to a leash training system with a novel attachment device and a method of using the same that provides for gentle correction and control of the dog.

### 2. Description of Related Art

Leash training systems are well known in the art and are effective means to control a dog. For example, FIG. 1 depicts a flowchart 101 of a conventional leash training system. During use, the user secures a collar to the dog and attaches a leash, as shown with boxes 103, 105. The user then uses the leash to control the dog by pulling on the leash, as shown with box 107. The collar then exerts pressure around the dog's neck as a form of control, as shown with box 109. This method can be painful and dangerous for the dog, and further results in limited control for the owner.

Currently there are a number of solutions for leashes that train dogs to walk gently beside their owners without excessive pulling, often labeled in the industry as “no-choke” or “no-pull” leashes. Some of these solutions attempt to train dogs with corrective pressure applied to the leashes that are wrapped around the dog's neck, known in the industry as “slip leads” or directly connected with a clasp to neck collars. These solutions fail to meet the needs of the industry because most slip leads that are fitted around the dog's neck risk choking and permanent injury to the dog's throat as the dog lunges away from the trainer, perhaps as an instinctive urge to react to other animals or distractions. Similarly neck collars attached directly to a leash may exert pressure on the dog's throat leading to the dog gagging or choking with discomfort and in extreme pulling by large dogs may inflict permanent damage to the dog's throat.

Other solutions attempt to provide a no-choke arrangement by slipping a snout harness arrangement around the dog's facial area but these solutions are similarly unable to meet the needs of the industry because they require complicated adjustment to fit correctly and not all dogs are comfortable with the harness arrangement around their snouts, thereby diminishing the comfort and enjoyment of preparing for a walk. During corrective action the dog's face is forced towards the owner in an attempt to provide a corrective signal however some dogs react negatively to this unnatural action resulting in increased distress and discomfort for the dog. It is also necessary to purchase the correct size snout harness to suit the size of the dog further complicating effective attachment and use of such devices.

Other solutions attempt to provide a no-choke arrangement by having an all-in-one leash and ring assembly that clips to the dog's neck collar and then loops the leash around the dog's chest cavity and back through the attached ring. These solutions are similarly unable to meet the needs of the industry because they are only suited to a single attachment, specifically neck collars. The fixed length snap clip and ring, if attached to a dog's body harness, positions the loop of the leash too far along the dog's torso, running the risk that pressure will be applied to the unprotected stomach area causing unnecessary discomfort to the dog and possible injury to soft organs. This type of device having a permanently attached metal fixing clasp and ring restrict the correct placement of the training leash in a way that is unsafe for the animal and may only be suited for attachment to neck collars.

Accordingly, although great strides have been made in the area of leash control systems, many shortcomings remain.

It would be desirable to have no-choke leash training device that can be used with either an existing neck collar or an existing chest harness which allows for easy attachment to the pet and is designed in such a way as to enable a variety of leash configurations to accommodate various dog breeds, sizes and shapes thereby facilitating the correct positioning of the looped leash safely around the dog's rib cage/chest area.

Furthermore, it would also be desirable to have a convenient, simple attachment device that is not permanently secured to the leash but can be carried separately and attached as needed.

Still further, it would be desirable to have an attachment device that accommodates convenient attachment of other accessories commonly carried during dog walking, such as dog waste bags, clip or collapsible water bowls.

It would be desirable to have a single device that gently and safely provides corrective leash pressure to a dog's chest area and can be quickly and securely attached to the dog's existing neck collar or existing body harness in such a way as to correctly position the looped leash safely around the dog's chest/rib cage.

The present invention relates generally to an attachment device (carabiner) that attaches to a dog's neck collar or chest harness and enables a rope leash to be safely positioned around the dog's rib cage/mid-section allowing the dog walker to apply gentle corrective tugs with the leash to the chest rather than the dog's neck and throat.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common leash control system;

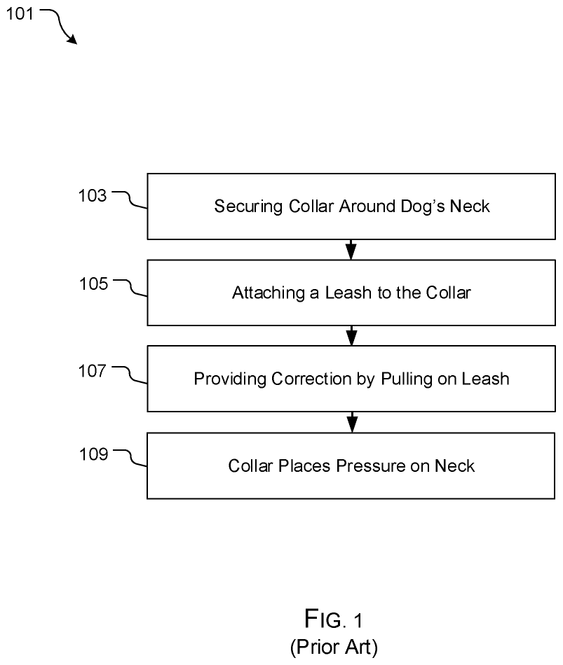

FIG. 2 is a front view illustration of an attachment device for use with a leash control system in accordance with a preferred embodiment of the present application;

FIG. 3 is an illustrative view of a leash control system with the attachment device secured to a dog collar;

FIG. 4 is an illustrative view of a leash control system with the attachment device secured to a dog harness; and

FIG. 5 is a flowchart of a method of use of the system of FIGS. 3 and 4.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional leash training systems. Specifically, the present invention provides for an attachment device configured to provide a means to secure a leash to the dog collar/harness and wrap around the rib-cage/mid-section of the dog to provide gentle corrective control of the dog. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

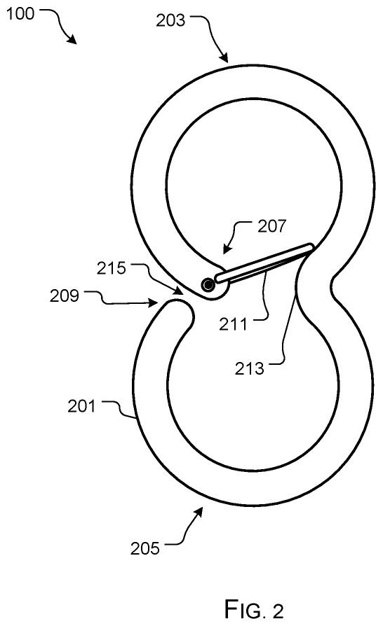

Referring now to the drawings wherein like reference characters identify corresponding or similar elements throughout the several views, FIG. 2 depicts a perspective illustration of an attachment device 100 in accordance with a preferred embodiment of the present application. It will be appreciated that attachment device 100 provides for a leash control system that overcomes one or more of the above-listed problems commonly associated with conventional leash control systems.

In the contemplated embodiment, attachment device 100 includes a body being formed by a frame 201 curved to form a top chamber 203 and a bottom chamber 205, being in substantially the shape of an 8. The frame 201 further includes a first end 207 and a second end 209. Attached to the first end 207 is a spring gate 211 which is configured to open inward into the top chamber and close against a curve 213 extending inward and opposite end 207.

In the preferred embodiment, the device 100 further includes a gap 215 positioned between the first end and the second end, wherein the gap 215 provides for an attachment to a neck collar or chest harness.

It should be appreciated that one of the unique features believed characteristic of the present application is the configuration of the attachment device which allows for the user to secure a leash around a mid-section of a dog to provide for improved gentle control.

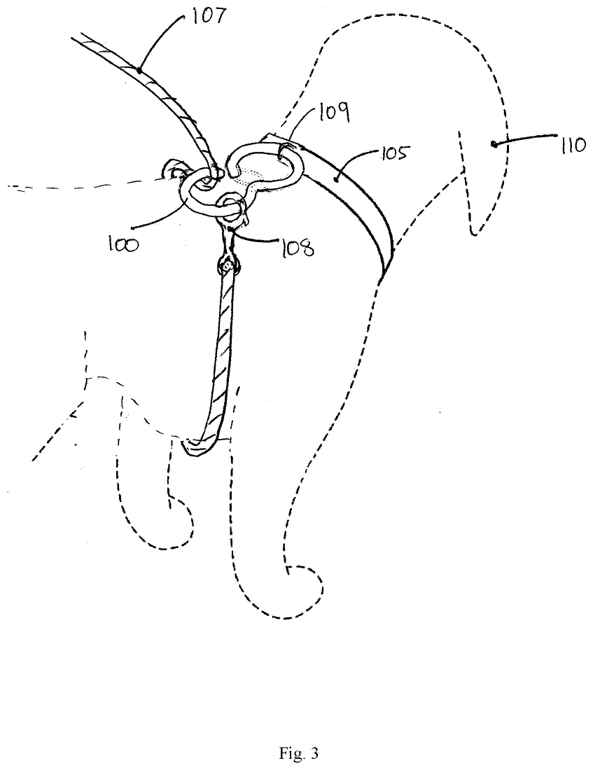

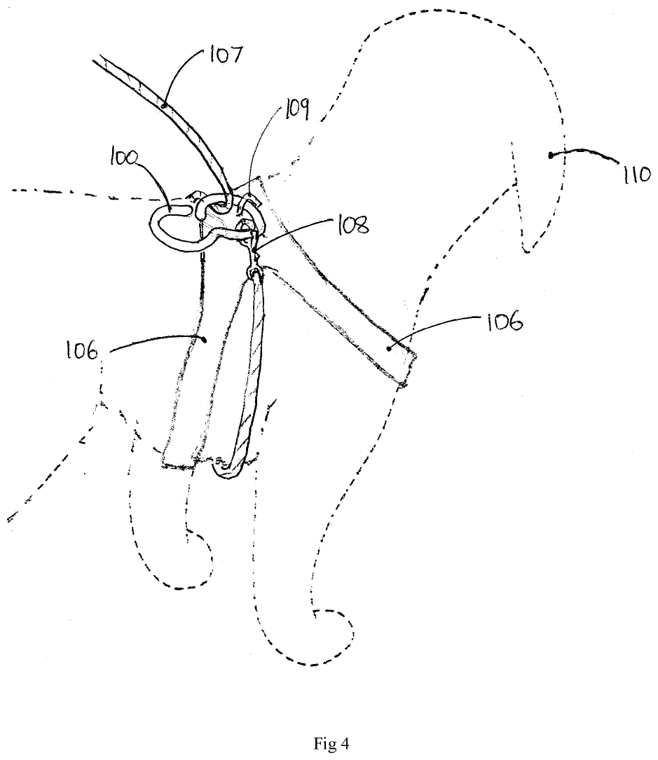

As shown in FIGS. 3 and 4, device 100 similar in shape to a figure of eight attaches to a dog's neck collar 105 or chest harness 106 using the top chamber 203 and is secured in place with the wire spring gate 211. A rope leash 107 with a clip 108 is attached to the chest harness ring 109 or directly to the device 100 and is then looped around the dog's chest rib cage and fed through either the top chamber 203 or bottom chamber 205 depending upon the which chamber facilitates the correct placement of the looped leash safely around the dog's chest.

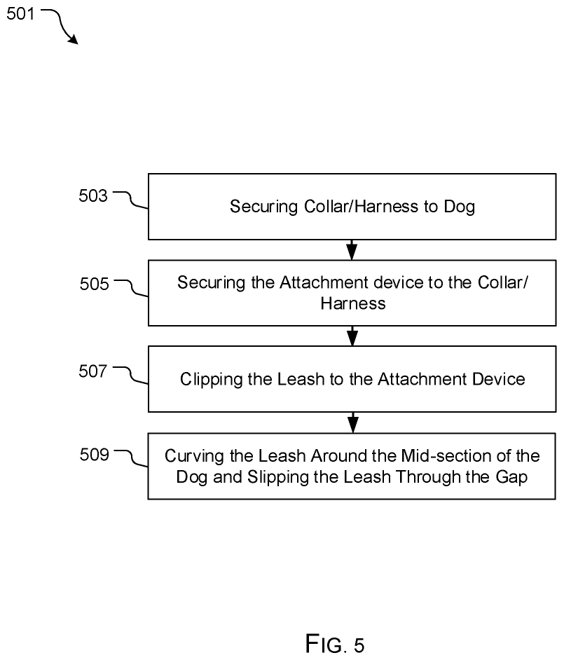

In FIG. 5, a flowchart represents the method of use of the present invention, wherein the user secures the harness or collar to the god and proceeds to attach the attachment device, as shown with boxes 503, 505. The user then clips the leash to the attachment device and curves the leash underneath the dog and slips a portion of the leash into the bottom chamber, as shown with boxes 507, 509.

It should be appreciated that the gap 215 in the lower chamber 205 helps facilitate easy attachment of the carabiner and rope leash and is sized and positioned to prevent accidental disengagement during normal operation.

The attachment device preferably includes rounded edges forming the body of the attachment device, which facilitates easy gliding of the rope leash without frictional binding facilitating instant release of pressure once the dog 110 responds in the desired way. During normal and desired dog walking activity the leash is loosely held and does not apply any corrective pressure to the dog's chest cavity. Should the dog lunge forward or engage in undesirable pulling away from his owner, short correct tugs on the leash result in temporary tightening pressure around the dog's chest signally the dog to correct their pulling and return to walking calmly. The device may also have one or more of the following variations:

In an embodiment, the top and bottom chambers may be shaped other than circular and could be oval, rounded triangular or a combination of shapes to facilitate rope positioning and may be of differing sizes, non-symmetrical.

In an embodiment, the attachment device lower chamber may also have an inwardly hinged spring activated gate.

In an embodiment, the attachment device may be fashioned with a slight upward bend in the middle forming a “butterfly” winged shape so as not to rest flat when placed on a horizontal surface.

In an embodiment, the attachment device body may be molded or stamped with a finished shape that does not resemble round bar stock

In an embodiment, the attachment device body may be fabricated from a variety of materials including but not limited to other non-ferrous metals and synthetic organic polymers or a composite of materials.

The present invention is unique when compared with other known devices and solutions because the present invention provides: (1) A simple and inexpensive detachable training device that can be safely used with either a dog's collar or a dog's chest harness without additional attachments or extensions (2) can accommodate a variety of attachment configurations to suit any dog's size and torso length while correctly positioning the looped body leash safely around the dog's protected rib cage/chest area and (3) is designed to facilitate smooth, unimpeded gliding of the rope leash during training allowing for quick application of corrective signaling and immediate release of pressure to the rib cage when the dog is behaving correctly (4) can accommodate accessories commonly hand carried during walks such as dog waste bags, clip on collapsible water bowls etc.

The disclosed device is unique in that it is structurally different from other known devices or solutions. More specifically, the device is unique due to the presence of: (1) the double round chambers that offer various attachment options (2) the attachment device is a complete and separate device from the leash allowing the use of existing round rope leashes; and (3) the attachment device can be made in various sizes and shapes to accommodate all breeds of dogs unlike no-pull leashes with fixed metal clasps with limited functional scalability.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An attachment device for use with a leash for training purposes, the attachment device comprising:
a body formed by a frame curved to form a top chamber and a bottom chamber;
the frame having a first end, a second end, and a curved portion extending inwardly and across from the first end;
a gap formed between the first end and the second end and providing access to the bottom chamber; and
a spring gate attached to the first end and configured to close against the curved portion, thereby closing off the top chamber.

2. The device of claim 1, wherein the body includes only smooth edges.

3. The device of claim 1, wherein the top chamber and bottom chamber are round.

4. The device of claim 1, wherein the spring gate opens inward into the top chamber.

5. A leash training system, comprising:
an attachment device, including:
a body formed by a frame curved to form a top chamber and a bottom chamber;
the frame having a first end, a second end, and a curved portion extending inwardly and across from the first end;
a gap formed between the first end and the second end and providing access to the bottom chamber; and
a spring gate attached to the first end and configured to close against the curved portion, thereby closing off the top chamber;
a dog control device configured to secure to a dog; and
a leash;
wherein the attachment device is configured to secure to the dog control device; and
wherein the leash is configured to secure to the attachment device via a clip and wrap around a mid-section of the dog and secure back to the attachment device by slipping a portion of the leash through the gap.

6. The system of claim 5, wherein the dog control device is a collar.

7. The system of claim 5, wherein the dog control device is a harness.

8. The system of claim 5, wherein the body includes only smooth edges.

9. The system of claim 5, wherein the top chamber and bottom chamber are round.

10. The system of claim 5, wherein the spring gate opens inward into the top chamber.

11. A method of leash training a dog, the method comprising:
securing a dog control device to the dog;
providing an attachment device having a body formed by a frame curved to form an upper chamber and a bottom chamber, the frame having a first end, a second end, and a curved portion extending inwardly and across from the first end; a gap formed between the first end and the second end and providing access to the bottom chamber; and a spring gate attached to the first end and configured to close against the curved portion, thereby closing off the top chamber;
securing the attachment device to the dog control device;
clipping a leash to the attachment device via a clip;
curving the leash underneath a mid-section of the dog and slipping a portion of the leash through the gap of the attachment device, thereby allowing for the leash to tighten and loosen around the mid-section; and
providing correction to the dog as needed with the leash.
